(19) United States
(12) Patent Application Publication
(10) Pub. No.: US 2014/0230673 A1
(43) Pub. Date: Aug. 21, 2014

(54) BLANKET TENSIONING DEVICE

(71) Applicants: Avichay Mor-Yosef, Jerusalem (IL); Israel Katz, Rehovot (IL)

(72) Inventors: Avichay Mor-Yosef, Jerusalem (IL); Israel Katz, Rehovot (IL)

(21) Appl. No.: 14/347,014

(22) PCT Filed: Sep. 25, 2011
(86) PCT No.: PCT/IL2011/000753

§ 371 Date: Mar. 25, 2014

(51) Int. Cl. B41F 27/12

(52) U.S. Cl. CPC B41F 27/1218
USPC 101/415.1; 101/492

(57) ABSTRACT

A blanket tensioning device for an image transfer medium (ITM) cylinder includes two elongated blanket holders. A long dimension of each blanket holder is substantially parallel to a long dimension of the other. At least a part of at least one of the blanket holders is moveable toward or away from the other blanket holder. The device includes at least one spring that, is longitudinally arranged with respect to the long dimension and a transmission for converting a force that is exerted by the spring to a transverse force that is applied to the moveable part. When the device is installed on the cylinder with the long dimension being oriented substantially parallel to an axis of the cylinder, and when a blanket is wrapped around the cylinder with each of opposite ends of the blanket being held by each of the blanket holders substantially parallel to the cylinder axis, the applied transverse force tensions the blanket.

### BACKGROUND

An offset or other type of (e.g. digital) printing process may include an intermediate transfer member (ITM) for transferring an image from a photo imaging plate (PIP) cylinder to a medium such as paper. The ITM may include a cylinder that is rotatable about its axis. As the cylinder is rotated, portions of its surface may come into contact with portions of the PIP cylinder, from which ink may be transferred. As the ITM cylinder continues to rotate, the ink may be transferred to a medium that is pressed between the ITM cylinder and an impression cylinder.

The outer surface of the ITM cylinder may include a replaceable blanket. (The ITM cylinder may thus sometimes be referred to as a blanket cylinder.) The ITM cylinder may thus include structure for grasping the blanket, and holding the blanket taut against the ITM cylinder surface. Typically, the blanket is wrapped around the cylinder surface, with the ends of the blanket being held by clips or similar holders that are mounted on the cylinder surface.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 shows a section of an ITM cylinder with a blanket tensioning device in accordance with an embodiment of the invention;

FIG. 2A shows a blanket tensioning device with two springs in accordance with an embodiment of the invention;

FIG. 2B shows the blanket tensioning device of FIG. 2B without its dynamic bar so as to show interior structures;

FIG. 3 illustrates a transmission mechanism of the blanket tensioning device shown in FIG. 2A;

FIG. 4A shows a transverse cross section of the blanket tensioning device shown in FIG. 2A when holding a blanket that is not tensioned;

FIG. 4B shows the blanket tensioning device shown in FIG. 4A when the blanket is tensioned;

FIG. 5A shows a blanket clamp operating mechanism for a blanket tensioning device in accordance with an embodiment of the invention, with the clamp closed;

FIG. 5B shows the blanket clamp operating mechanism of FIG. 5A with the clamp opened;

FIG. 6 shows a blanket clamp operating mechanism for a blanket tension device in accordance with another embodiment of the invention;

FIG. 7 shows blanket clamp for a blanket tensioning device in accordance with another embodiment of the invention; and

FIG. 8 shows a blanket tensioning device with four longitudinally arranged gas springs, in accordance with an embodiment of the invention.

### DETAILED DESCRIPTION

In accordance with an embodiment of the invention, a blanket tensioning device for tensioning a blanket that is wrapped around a surface of an ITM cylinder tensions the blanket so that the blanket is held taut against the cylinder surface. The blanket tensioning device includes at least two elongated blanket holders, each blanket holder configured to hold or attach to one of two opposing ends of the blanket. The blanket holders may be installed in a longitudinal groove on the cylinder surface. For example, one or both blanket holders may be in the form of, or include, an elongated bar that may be installed on the ITM cylinder such that its long axis is oriented substantially parallel to the axis of the ITM cylinder.

Longitudinal axes of the two blanket holders (axes parallel to the long dimension of each of the elongated blanket holders) are substantially parallel to one another. Thus, each end of the blanket may be held substantially parallel to the axis of ITM cylinder by one of the blanket holders. At least a part of one or both of the bars may be moveable. When a transverse force (e.g. in a direction that is perpendicular to the longitudinal axes) is applied to a moveable part that forces the moveable part of the moveable bar toward the other bar, the blanket may be tensioned.

For example, one or both of the bars may be rotatable toward and away from the other about a rotation axis that is substantially parallel to the cylinder axis. When a torque is applied to one (or both) of the bars so as to rotate the bars toward one another, the blanket may be tensioned.

One or more springs that are longitudinally oriented with respect to the elongated blanket holders to as to fit within a longitudinal (substantially parallel to the cylinder axis) groove on the surface of the ITM cylinder. For example, the springs may be positioned between the blanket holders. A transmission is provided for converting a longitudinal force (along the axis of the spring) produced by each spring to a transverse force that is substantially perpendicular to the long dimension of the groove. The transverse force may be applied to the moveable bar or bars such as to push the bars toward one another. For example, if the moveable bar is a rotatable bar, the transverse force may be applied as a torque to the rotatable blanket-holding bar (or to both bars when both are rotatable). When ends of the blanket are held by the blanket holders, the torque that is applied to the rotatable bar may tension the blanket and hold it taut against the surface of the ITM cylinder. For example, the torque may be such as to push a distal edge (an edge furthest from the axis of the ITM cylinder) of a blanket holder in the form of a rotatable bar toward the other blanket holder.

As used herein, a spring is considered to be longitudinally arranged if the long axis of the spring is oriented closer to the length (long dimension) of the groove than to a transverse dimension (plane perpendicular to the long dimension) of the groove (e.g. the spring axis being within 45 degrees of the cylinder or groove axis). In this manner, the length of the spring may be made much longer (e.g. twice as long as, or more) than the width of the groove. Typically, the width of the groove may create a strip on the surface of the ITM cylinder that cannot be utilized for printing. Therefore, it may be a design goal to make the groove width as small as possible so as to maximize the area that may be used for printing. Thus, a spring that is longitudinally arranged may be made much longer than a spring that was transversely arranged. A blanket tensioning device in accordance with an embodiment of the invention may be configured such that an orientation of a spring changes with its length (e.g. so as to effectively cooperate with other components of the blanket tensioning device).

As used herein, a spring may be understood to include any element that is capable of exerting a restoring force when stretched or compressed. For example, a spring may include a mechanical spring such as a helical or coil spring, a resilient band or rod, a gas-filled piston or spring, a hydraulic piston, or an electromagnetic actuator. A stiffness of the spring may be characterized by a linear spring constant (e.g. in accordance with Hooke's law) or similar elastic modulus or quantity. For example, tensioning of the blanket may be accomplished by compressing (or stretching) the spring. The change in length of the spring may be limited by available space. For example, were a spring to be oriented transversely in the groove, as in prior art blanket tensioning devices, the change in length would be limited to a fraction of the width of the groove (the entire working length of the spring when installed being limited to less than the width). Therefore, the spring would typically, in the case of the prior art device, be required to have a high spring constant (be very stiff) in order to provide a required tensioning force.

Orienting the spring longitudinally within the groove, in accordance with embodiments of the present invention, may enable using a spring whose length is longer than the width of the groove. For example, in some embodiments, the length of the groove may he approximately equal to ten times the width of the groove and two or four springs may be arranged longitudinally within the length of the groove. In such a case, the length of each spring could be up to one quarter of the length of the groove, or about 5 times (for two springs) or 2.5 times (for four springs) the width of the groove, with the available change in length for providing a tensioning force being similarly proportionally larger. Thus, when the spring is oriented longitudinally, the spring could have a lower spring constant than would a transversely oriented spring.

A blanket that is tensioned by the blanket tensioning device may stretch with use, in time, or in response to a mechanical stress or environmental conditions (e.g. temperature, humidity). In addition, the dimensions of blankets as manufactured may vary slightly from blanket to blanket in accordance with a manufacturer's tolerances. Since the lengths (herein referring to the dimension of the blanket that is wrapped axially about curved surface of the ITM cylinder) of the blankets may vary, tensioning of a blanket may require the spring to be compressed (or stretched) by varying amounts in order to hold the blanket taut against the surface of the ITM cylinder. Such varying amounts of compression (or stretching) of the spring may change the tensioning force that is exerted on the blanket so as to hold the blanket taut.

Use of a spring or resilient element to tension the blanket may maintain the tautness of the blanket when the length of the blanket changes without any further action on the part of an operator or a device controller. On the other hand, use (as in some prior art devices) of a non-resilient element (e.g. a screw-operated tensioning device) may require constant monitoring and active adjustment of the tensioning of the blanket.

Since a shorter spring (as in the prior art), as discussed above, would generally have a large spring constant, such a variation in compression may be expected to lead to a large change in the tensioning force. For example, a longer blanket could result in a reduction of tensioning force that could enable the blanket to loosen sufficiently such that regions of the blanket could move relative to the surface of the ITM cylinder. Excessive movement (sometimes referred to as blanket creep or crawl), or reduction of tensioning of the blanket, could adversely affect printing quality. For example, blanket crawl could affect transfer of an image from a PIP cylinder to the ITM blanket or from the ITM blanket to the printing medium. Operation of a printer may be affected by non-uniform heating (and expansion) of the ITM cylinder, or inaccurate temperature measurements (for compensation purposes), blanket abrasion, blanket buckling, or reduced blanket life.

In accordance with an embodiment of the invention, a longitudinally oriented spring may be made sufficiently long so as to enable utilization of a spring with reduced spring constant. Such a reduced spring constant may thus reduce variation in tensioning forces in response to variability or changes in blanket length. As a result, a substantially reproducible and constant tensioning force may be applied to the blanket. This force may be designed to be sufficient to inhibit or prevent blanket creep or crawl.

A transmission for converting a longitudinal force of the spring to a transverse tensioning force on the blanket may include a lever, linkage, gear, cam, rack and pinion, hydraulic transmission, or similar mechanical device for converting a force in one direction to a force in another.

A blanket tensioning device in accordance with an embodiment of the invention may include a single unit that is installable in or removable from the longitudinal gap in the cylinder surface.

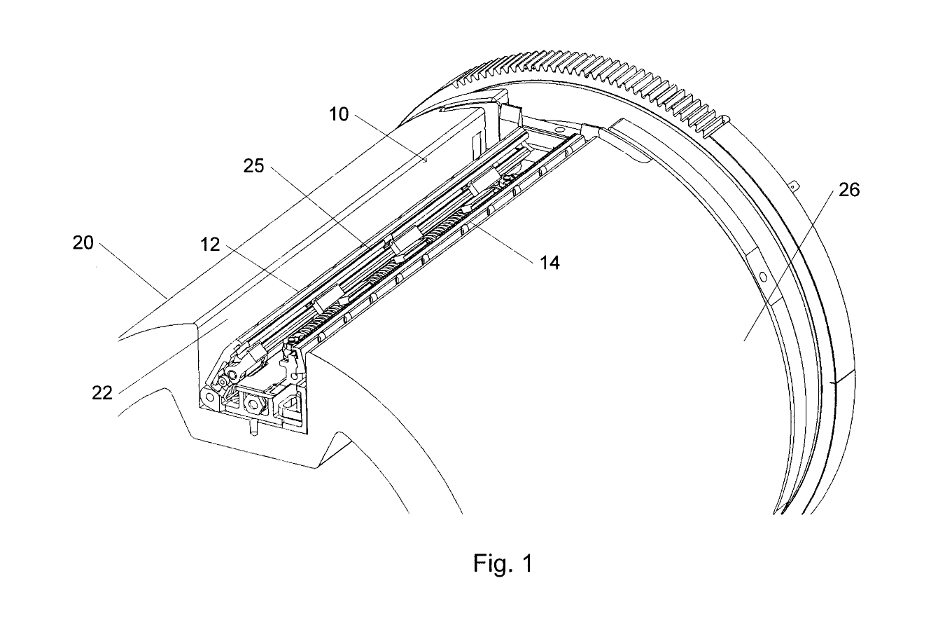

FIG. 1 shows a section of an ITM cylinder with a blanket tensioning device in accordance with an embodiment of the invention.

Blanket tensioning device 10 is positioned within gap 22 of ITM cylinder 20. A blanket 25 (only one end is shown) may be wrapped around surface 26 of ITM cylinder 20, with the ends of blanket 25 held and tensioned by blanket tensioning device 10. For example, one end of blanket 25 may be held by static bar 14 of blanket tensioning device 10 and the other by dynamic bar 12 of blanket tensioning device 10.

In accordance with another embodiment of the invention, function of static bar 14 may be provided by structure that is fixed to ITM cylinder 20 (e.g. the structure including a mechanism for attaching an end of the blanket to one side of gap 22). In accordance with another embodiment of the invention, static bar 14 may be replaced with a second dynamic bar.

Thus, all of surface 26 of ITM cylinder 20 may be covered by blanket 25 with the exception of gap 22. When ITM cylinder 20 is incorporated into an offset printing device, ink in the form of a deposited image may be transferred from an adjacent PIP cylinder to blanket 25. The ink on blanket 25 may then be transferred to a printing medium that is held between ITM cylinder 20 and an adjacent impression roller. Since no ink may be transferred to or from the region of gap 22, rotation of ITM cylinder 20 may be synchronized with rotation of the PIP cylinder and motion of the printing medium. For example, the PIP cylinder and ITM cylinder 20 may have similar diameters and rotate at similar rates such that a single region of the PIP cylinder always contacts gap 22. Thus, the printing device may be configured such that no ink of the image is ever deposited on the region of the PIP that contacts gap 22.

Each end of blanket 25 may be provided with a stiffened section, end bar, tab, or other feature that may be held by clamping mechanism (e.g. clamp, clip, hook, or other holding mechanism) of blanket tensioning device 10.

For example, blanket tensioning device 10 may be manipulated (e.g. by an incorporated actuation mechanism that may be operated by application of an external force, e.g. to a screw) to apply a force to rotate dynamic bar 12 outward away from static bar 14 (thus reducing a tensioning force applied by dynamic bar 12). Clamps on dynamic bar 12 and on static bar 14 may be opened (e.g. separately) to enable insertion of an end of blanket 25, such as a blanket end bar, and then closed so as to clamp each end of blanket 25 to dynamic bar 12 or static bar 14, respectively. The actuation mechanism may then be operated to enable force provide by springs that are longitudinally arranged along blanket tensioning device 10 (and gap 22) to apply a torque to force dynamic bar 12 inward toward static bar 14. Forcing dynamic bar 12 inward toward static bar 14 may thus provide a tensioning force for tensioning blanket 25 against surface 26.

As another example, a dynamic bar may be configured to move toward or away from a second bar (e.g. a static bar or second dynamic bar). For example, the dynamic bar may be configured to move along a track (or tracks), or may be constrained by guides, so as to be moveable toward or away from the second bar. In this case, forcing the dynamic bar in a direction away from the second bar may provide a tensioning force on a blanket attached to the dynamic bar and the second bar.

The longitudinally arranged springs of blanket tensioning device 10 may include various numbers of springs, and various types of springs.

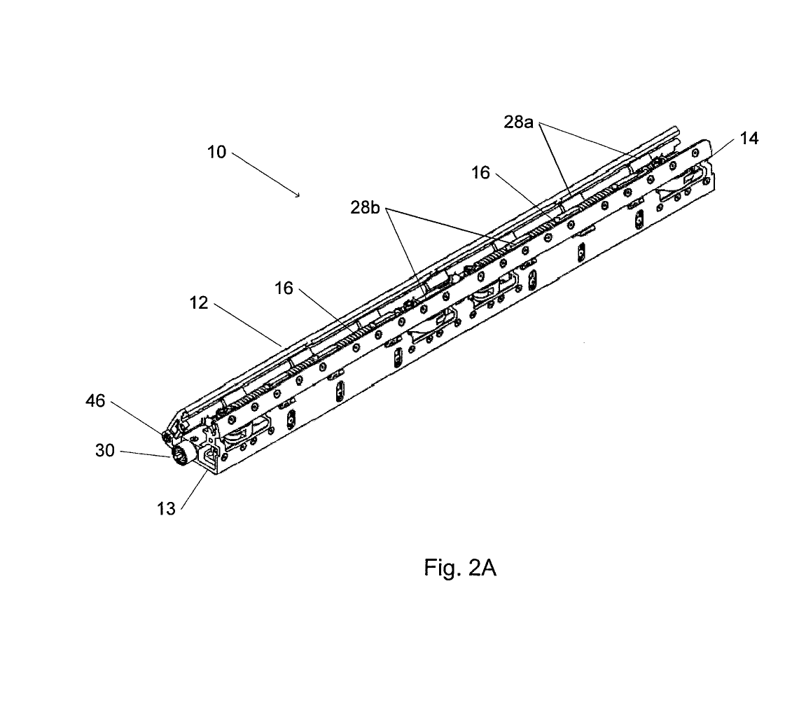

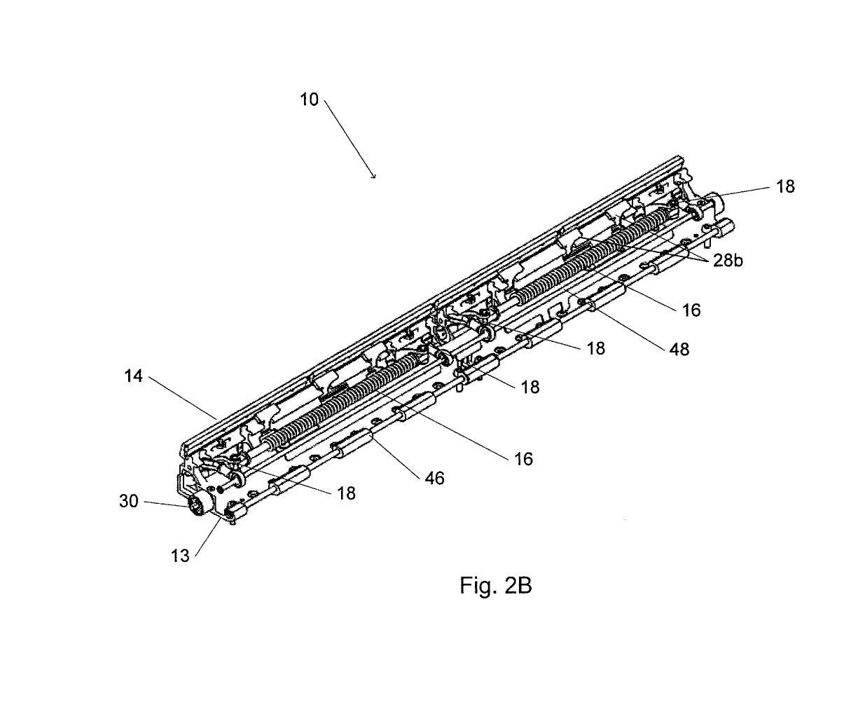

FIG. 2A shows a blanket tensioning device with two springs, in accordance with an embodiment of the invention. FIG. 2B shows the blanket tensioning device of FIG. 2B without its dynamic bar so as to show interior structures.

Blanket tensioning device 10 includes springs 16. Although two springs 16 are shown, either one spring or more than two springs could be used. Although coil springs are shown, spring 16 may include any suitable type of linear spring or resilient element. Springs 16 are shown as oriented parallel to a long axis of blanket tensioning device 10, and to groove 22 (FIG. 1) inside which blanket tensioning device 10 is located. Other longitudinal orientations are also possible.

Spring 16 of blanket tensioning device 10 may be configured as a compression spring. For example, spring 16 may include a coil spring that surrounds a shaft with an axial bore, and a plunger that is configured to move in and out of the bore. One end of the coil spring may push against an end of the shaft, and another against an opposite end of the plunger. Thus, the coil spring may be compressed by pushing the plunger further into the bore. A restoring force of the spring may then push the plunger back out of the bore. The shaft and bore may constrain spring 16 to maintain a linear configuration and not bend or buckle. In other examples, a linear configuration of spring 16 may be maintained by other constraining elements. For example, spring 16 may be at least partially confined within a tube.

In this manner, or in a similar manner, spring 16 may be compressed such that a restoring force of spring 16 is redirected by transmission 18 (components of transmission 18 in accordance with an embodiment of the invention are described below) to apply a force to dynamic bar 12 (e.g. to dynamic bar rod 48 that is partially enclosed within an interior bore of dynamic bar 12) that causes a distal edge of dynamic bar 12 to rotate about dynamic bar axis 46 toward static bar 14.

The distal edges of dynamic bar 12 and of static bar 14 include blanket clamps 28a and 28b respectively. Blanket clamps 28b may be opened to insert an end of a blanket and closed to hold the inserted blanket end to static bar 14. Similarly, blanket clamps 28b may be opened to insert an end of a blanket and closed to hold the inserted blanket end to dynamic bar 12. For example, a mechanism for opening and closing blanket clamps 28a and 28b, and for compressing or releasing spring 16, may be activated by rotating actuation screw 30. For example, the mechanism for opening and closing blanket clamps 28a and 28b may be coupled (e.g. by a cam follower) to a cam that is moved by rotation of actuation screw 30.

Transmission 18 may include a lever linkage.

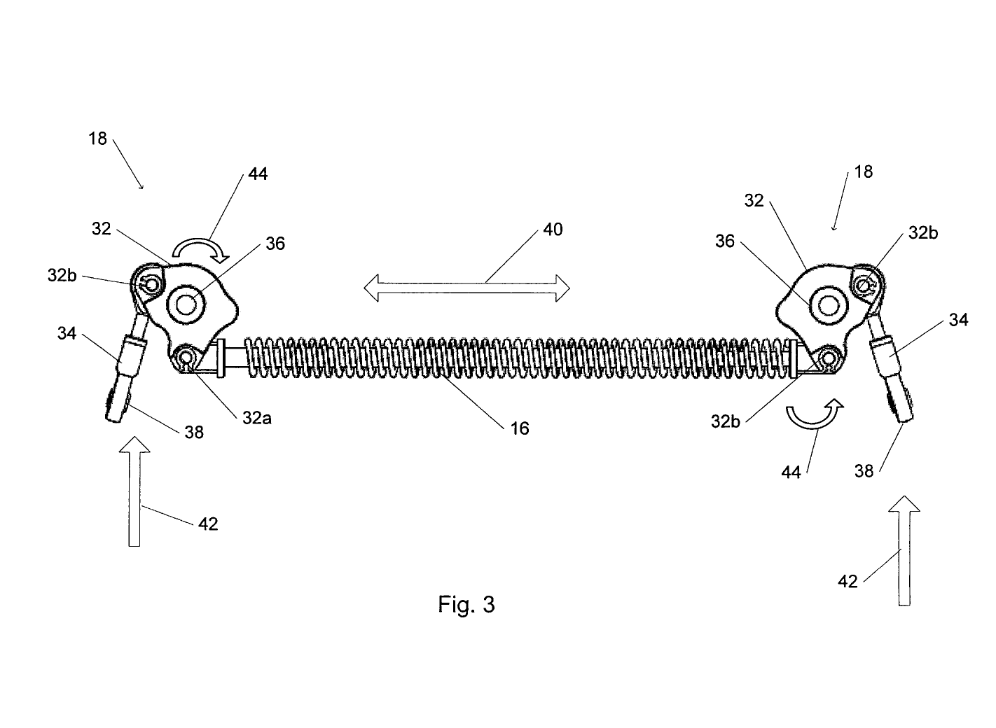

FIG. 3 illustrates a transmission mechanism of the blanket tensioning device shown in FIG. 2A. Spring 16 when compressed applies forces as indicated by double arrow 40. Forces are applied by each end of spring 16 to connection point 32a of lever linkage 32. Lever linkage 32 may pivot about pivot point 36, which may be fixed to floor 13 (FIG. 2A and FIG. 2B) of blanket tensioning device 10. The force applied to connection point 32a may cause lever linkage 32 to rotate about pivot point 36 in the direction indicated by arrow 44. Rotation of lever linkage 32 about pivot point 36 may pull connection point 32b and pull rod 34 in the direction indicated by arrow 42. Bar connector 38 at an end of pull rod 34 may connect pull rod 34 to dynamic bar 12 (FIG. 2A), e.g. to dynamic bar rod 48 (FIG. 2B) that is held within an interior bore of dynamic bar 12. Thus, a force on bar connector 38 in the direction indicated by arrow 42 may pull dynamic bar 12 toward static bar 14, thus tensioning a blanket whose ends are clamped to dynamic bar 12 and to static bar 14.

Although as illustrated in FIG. 3, a transmission 18 is coupled to each end of spring 16, other configurations are possible. For example, one end of a spring (e.g. coil spring or gas spring) may be fixed (e.g. to structure connected to floor 13), while a transmission is provided only at the other end of the spring.

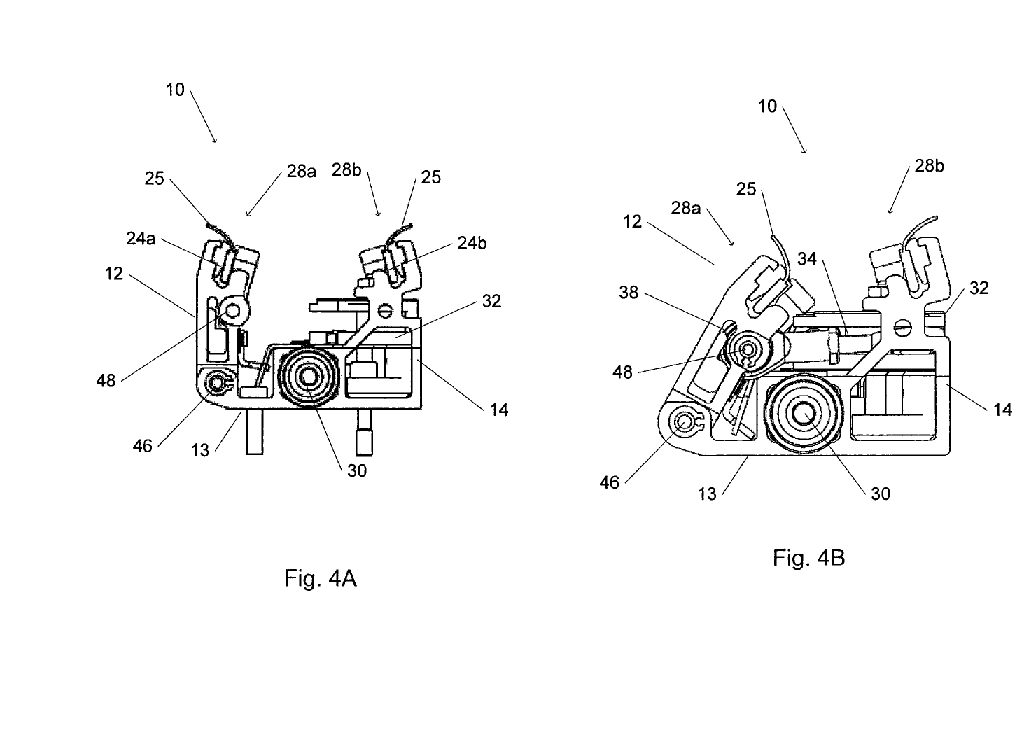

FIG. 4A shows a transverse cross section of the blanket tensioning device shown in FIG. 2A when holding a blanket that is not tensioned. For example, a cam or similar mechanism that is activated by rotation of actuation screw 30 may apply a counter-toque to dynamic bar 12 via rotation of lever linkage 32 or pushing of pull rod 34. For example, lever linkage 32 may include a cam follower (e.g. in the form of a wheel) so that lever linkage may rotate in response to motion of a cam that is coupled to actuation screw 30. Pushing pull rod 34 may push bar connector 38 against dynamic bar rod 48 so as to force dynamic bar 12 to rotate about dynamic bar axis 46 away from static bar 14. Concurrently, a spring of blanket tensioning device 10, such as spring 16 (FIGS. 2A and 2B) may be compressed.

Each end of blanket 25 (only ends of blanket 25 are shown partially) is clamped to one of dynamic bar 12 and static bar 14. For example, a blanket end bar 24a at one end of blanket 25 may be held by blanket clamps 28a of dynamic bar 12. Similarly, a blanket end bar 24b at another end of blanket 25 may be held by blanket clamps 28b of static bar 12. The remainder (mostly not shown) of blanket 25 may be wrapped around surface 26 of ITM cylinder 26 (FIG. 1). Thus, rotating dynamic bar 12 away from static bar 14 may reduce or release tensioning of blanket 25.

In order to tension blanket 25, dynamic bar 12 may be rotated about dynamic bar axis 46 toward static bar 14.

FIG. 4B shows the blanket tensioning device shown in FIG. 4A when the blanket is tensioned. For example, continued rotation of actuation screw 30 may move the cam (or similar component of the actuation mechanism) that forced rotation of lever linkage 32 or pushing of pull rod 34 so as to no longer provide the rotating or pushing force. When the force is no longer provided, a restoring force of compressed spring 16 (FIG. 3), or elastic force, may operate components of transmission 18, such as lever linkage 32 and pull rod 34, to pull on dynamic bar 12. For example (as shown in FIG. 3), bar connector 38 at an end of pull rod 34 may pull on dynamic bar rod 48, thus pulling on dynamic bar 12. Pulling on dynamic bar 12 may cause dynamic bar 12 to rotate about dynamic bar axis toward static bar 14. Thus, blanket end bar 24a at one end of blanket 25, and that is held by blanket clamps 28a of dynamic bar 12, may be pulled away from blanket end bar 24b at the other end of blanket 25, and which is held by blanket clamps 28b of static bar 14. Pulling blanket end bar 24a away from blanket end bar 24b may thus tension blanket 25 that is wrapped around surface 26 of ITM cylinder 26 (FIG. 1).

A blanket clamp 28a or 28b for holding an end of a blanket 25 may be operated (e.g. opened or closed) by an actuation mechanism, e.g. a mechanism that is operated by rotation of actuation screw 30.

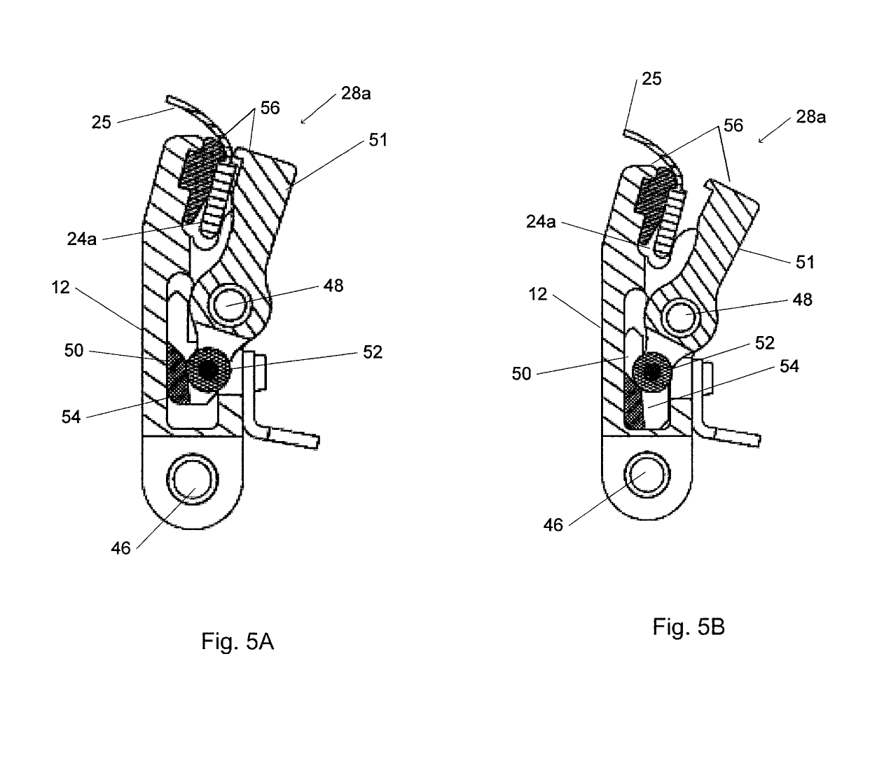

FIG. 5A shows a blanket clamp operating mechanism for a blanket tensioning device in accordance with an embodiment of the invention, with the blanket clamp closed. Although FIG. 5A shows an operating mechanism for a blanket clamp 28a on dynamic bar 12, a similar operating mechanism may operate blanket clamp 28b on static bar 14 (FIG. 4A).

Blanket clamp 28a on dynamic bar 12 may be opened and closed by up-and-down motion of actuation bar 50. For example, actuation bar 50 may be moved up and down by a mechanism actuated by a cam or similar actuation mechanism. The cam may be moved, e.g. by a mechanism that is operated by rotation of actuation screw 30 (FIG. 2A).

For example, when actuation bar 50 is raised, as shown in FIG. 5A, track 54 of actuation bar 50 may push actuation wheel 52 of clamp rocker arm 51 of blanket clamp 28a inward (e.g. toward the right in FIG. 5A, toward static bar 14 shown in FIG. 4A). Inward pushing of actuation wheel 52 may rotate clamp rocker arm 51 about dynamic bar rod 48 (or about a similar axis of static bar 14) so as to push clamp jaws 56 together. Thus, a blanket end bar 24a at one end of blanket 25 may be held firmly by blanket clamp 28a.

When blanket 25 is to be removed and replaced, blanket clamp 28a may be operated to release blanket end bar 24a and to enable insertion of another blanket end bar 24a.

FIG. 5B shows the blanket clamp operating mechanism of FIG. 5A with the clamp opened. For example, when actuation bar 50 is lowered, as shown in FIG. 5B, track 54 of actuation bar 50 may push actuation wheel 52 of clamp rocker arm 51 of blanket clamp 28a outward (e.g. toward the left in FIG. 5B, away from static bar 14 shown in FIG. 4A). Outward pushing of actuation wheel 52 may rotate clamp rocker arm 51 about dynamic bar rod 48 (or about a similar axis of static bar 14) so as to separate clamp jaws 56. Thus, a blanket end bar 24a at one end of blanket 25 may be removed from or inserted into blanket clamp 28a. Further action by the activation mechanism may close blanket clamp 28a, as shown in FIG. 5A.

A similar opening and closing mechanism may operate (open or close) blanket clamp 28b on static bar 14 of blanket tensioning device 10 (FIG. 4A).

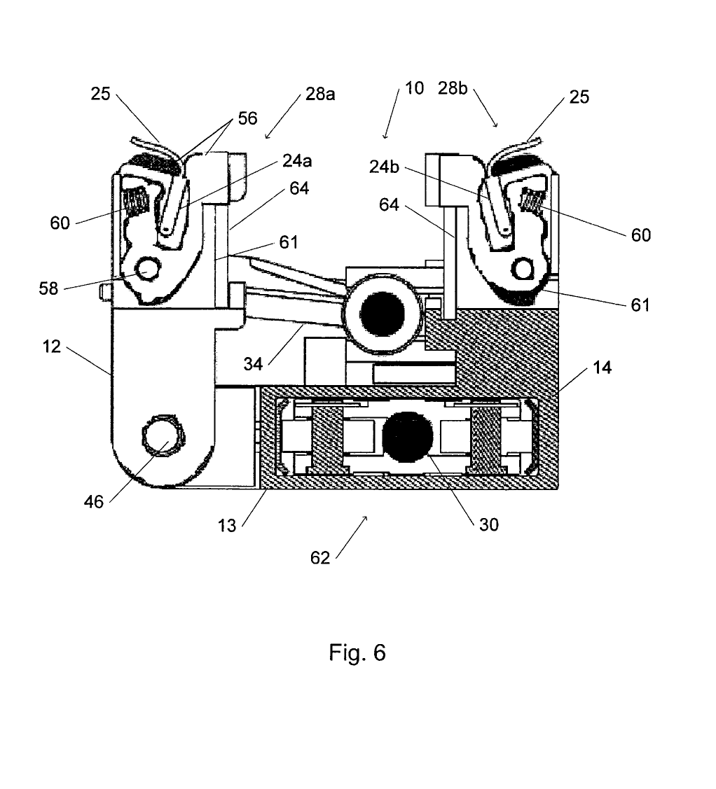

FIG. 6 shows another blanket clamp operating mechanism for a blanket tensioning device in accordance with another embodiment of the invention.

Blanket clamps 28a and 28b may be operated (e.g. opened and closed) by operation of activation assembly 62. For example, activation assembly 62 may include one or more longitudinally translatable bars or nuts that may be longitudinally translated (along a long axis of blanket tensioning device 10) by rotation of actuation screw 30. For example, a longitudinally translatable bar may be provided with one or more cams, or may in turn move one or more other components that are provided with cams. As the cam is longitudinally translated, the cam may interact with cooperating structure (e.g. cam follower) of one or more activation devices. For example, each set of blanket clamps 28a or of 28b may be opened or closed in response to a longitudinal position of the cam. Similarly, a mechanism for rotating dynamic bar 12 about dynamic bar axis 46 may be actuated in accordance with a longitudinal position of the cam.

As another example, operation of activation assembly 62 may operate one or more gear, lever, or linkage assemblies.

For example, each blanket clamp 28a or 28b may include a clamp rocker arm 61 that may rotate about rocker arm pivot 58. Each blanket clamp 28a or 28b may also include a cam operated bar 64 that may be pushed against clamp rocker arm 61 so as to close clamp jaws 56. When cam operator bar is removed from pushing against clamp rocker arm 61, spring 60 may push clamp rocker arm 61 in the opposite direction. Pushing clamp rocker arm 61 in the opposite direction may cause clamp jaws 56 to open. Opening clamp jaws 56 may enable removal of blanket end bar 24a or 24b from blanket clamp 28a or 28b, respectively, or insertion of a blanket end bar 24a or 24b into blanket clamp 28a or 28b, respectively.

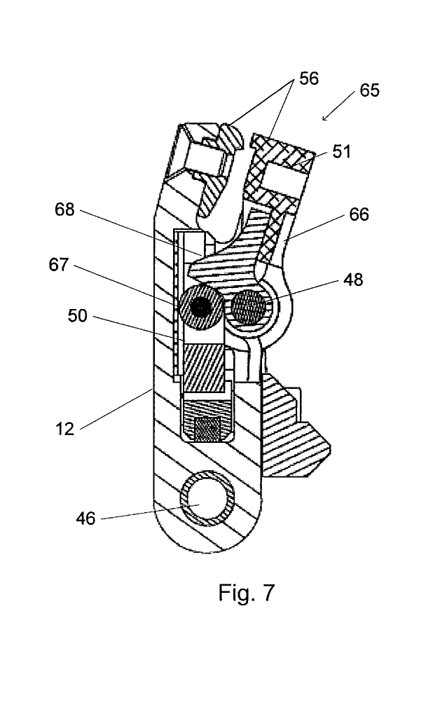

FIG. 7 shows a blanket clamp for a blanket tensioning device in accordance with another embodiment of the invention. Although blanket clamp 28a is shown in FIG. 7 as incorporated into dynamic bar 12 of a blanket tensioning device, a similar blanket clamp may be incorporated into a static bar of a blanket tensioning device.

Spring clip 66 of blanket clamp 28a is configured to rotate clamp rocker arm 51 about dynamic arm rod 48 (or about a similar axis of a static bar) so as to close clamp jaws 56. Thus, in the absence of an externally applied force, clamp jaws 56 may be maintained in a closed state by spring clip 66 so as to grasp or clamp an end of a blanket or a blanket end bar.

When removing, inserting, or replacing a blanket, clamp jaws 56 may be is opened and then allowed to close. For example, clamp jaws 56 may be opened and closed by up-and-down motion of actuation bar 50. For example, actuation bar 50 may be moved up and down by a mechanism actuated by a cam or similar actuation mechanism. The cam may be moved (e.g. longitudinally translated), e.g. by a mechanism that is operated by rotation of actuation screw 30 (FIG. 2A).

For example, when actuation bar 50 is raised, may push actuation wheel 67 upward against contoured arm 68. Pushing contoured arm 68 may rotate clamp rocker arm 51 about dynamic bar rod 48 (or about a similar axis of a static bar) so as to open clamp jaws 56. When actuation bar 50 is then lowered, spring clip 66 may close clamp jaws 56 and hold them closed.

In accordance with embodiments of the invention, other configurations of a blanket tensioning device are possible. For example, the blanket tensioning device may include more or fewer than two springs, and may include springs that are not coil springs. For example, an embodiment of the invention may include a blanket tensioning device with gas springs. For example, a blanket tensioning device, in accordance with an embodiment of the invention, with four gas springs may provide a greater tensioning force with a lower equivalent spring constant than a similar blanket tensioning device with fewer springs or coil springs.

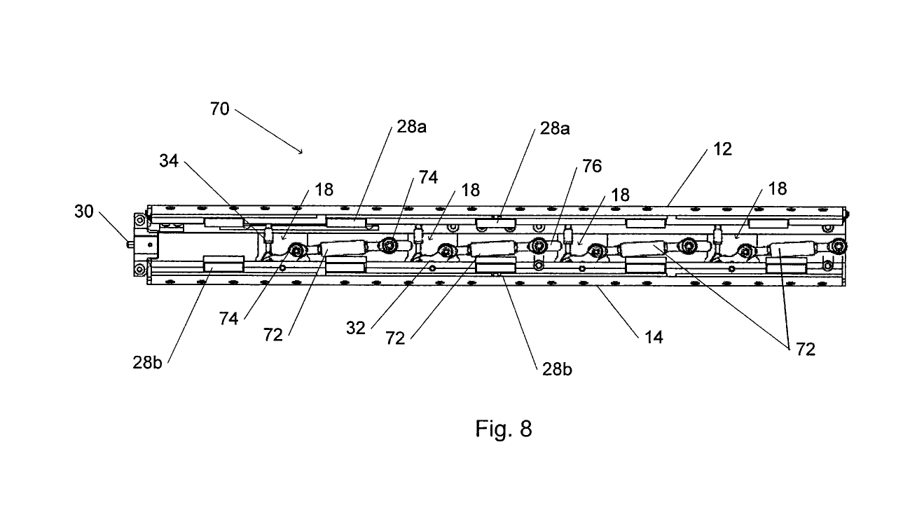

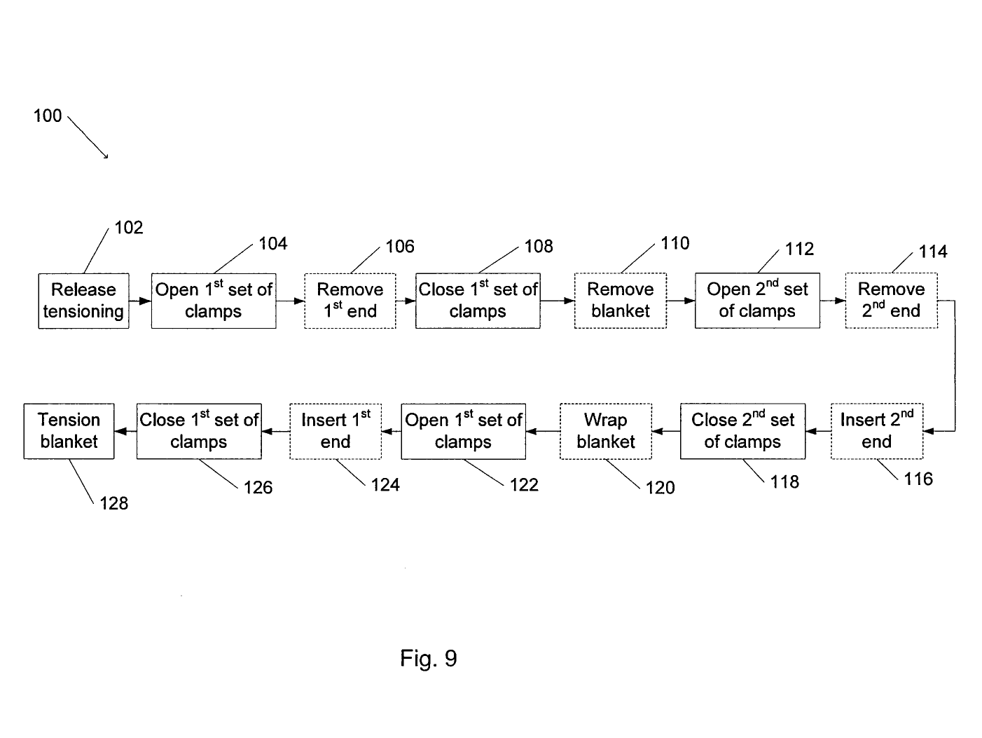

FIG. 8 shows a blanket tensioning device with four longitudinally arranged gas springs, in accordance with an embodiment of the invention. Blanket tensioning device 70 includes four gas springs 72. One end of each gas spring 72 is connected to lever linkage 32, and the other to stationary connector 76, each via a pivoting connection 74. Thus, gas spring 72 may change its orientation, e.g. when its length changes as a result of an applied force or due to rotation of lever linkage 32.

A blanket tensioning device in accordance with an embodiment of the invention may be operated so as to enable replacement of a blanket. FIG. 9 illustrates a process for replacing a blanket on an ITR cylinder using a blanket tensioning device in accordance with an embodiment of the invention. Blanket replacement process 100 may include manipulation of a configuration of the blanket tensioning device (indicated by a solid border of the corresponding block of the diagram), or actions performed by a user (indicated by a dashed border). Reference is made to components shown, e.g., in FIGS. 4A, 4B, and 6.

Operation of activation mechanism 62, e.g. by rotation of activation screw 30 first in one direction, and then in a reverse direction, may cause a sequence of manipulations of blanket tensioning device 10 (to be understood within the context of discussion of FIG. 9 to refer also to blanket tensioning device 70) so as to facilitate replacement of a blanket 25. For example, one or more cams may be linearly translated, e.g. longitudinally along blanket tensioning device 10, so as to actuate various cooperating structure, mechanisms, or devices.

For example, in accordance with an embodiment of the invention, rotation of activation screw 30 may first cause rotation of dynamic bar 12 about dynamic bar axis 46 away from static bar 14 so as to release tensioning of blanket 25 (block 102). Further rotation of activation screw 30 may cause a first set of blanket clamps, e.g. blanket clamps 28b on static bar 14, to open (block 104), enabling removal of a first blanket end bar, e.g. blanket end bar 24b (block 106). Further rotation of the activation screw 30 may cause the first set of blanket clamps (e.g. blanket clamp 28b) to close (block 108). The blanket may then be removed from the outer surface of the ITM cylinder, e.g. while rotating the ITM cylinder either automatically or manually (block 110). Finally, further rotation of activation screw 30 may cause the second set of blanket clamps (e.g. of blanket clamps 28a on dynamic bar 12) to open (block 112), enabling removal of the second blanket end bar, e.g. blanket end bar 24a (block 114). Thus, removal of blanket 25 from the ITM cylinder may be completed.

At this point, the actions may be reversed so as to install a new blanket 25: The second blanket end bar of the new blanket, e.g. blanket end bar 24a, may be inserted into the open second set of blanket clamps, e.g. blanket clamps 28a on dynamic bar 12 (block 116). Reverse rotation of the activation screw 30 may then cause the second set of blanket clamps (e.g. blanket clamps 28a) to close (block 118), thus clamping the second blanket end bar (e.g. blanket end bar 24a). The new blanket 25 may then be wrapped around the ITM cylinder, e.g. while rotating the ITM cylinder (block 120). Further reverse rotation of the activation screw 30 may then open the first set of blanket clamps, e.g. blanket clamps 28b on static bar 14 (block 122). The first end tab of the new blanket, e.g. blanket end bar 24b, may then be inserted into the open first set of blanket clamps, e.g. blanket clamps 28b (block 124). Further reverse rotation of the activation screw 30 may then cause the first set of blanket clamps (e.g. blanket clamps 28b) to close (block 126), thus clamping the first end tab of the new blanket (e.g. blanket end bar 24b). At this point, the new blanket 25 is attached to the ITM cylinder. Further reverse rotation of the activation screw 30 may then cause rotation of dynamic bar 12 about dynamic bar axis 46 toward static bar 14, thus tensioning blanket 25 (block 128). Thus, the replaced blanket 25 is held taut around the ITM cylinder.

The order of operations may be varied. For example, the order in which blanket clamps 28a and 28b are opened or closed may be changed, or blanket clamps 28a and 28b may be opened or closed concurrently.

Activation screw 30 may be rotated by a motor that is incorporated in, or associated with, a printing device that includes the ITM cylinder. For example, a controller of the printing device may control a motor to rotate activation screw 30 in response to an operator-generated input or command, or in response to a sensed state (e.g. blanket end bar removed from, or inserted in, a blanket clamp; blanket wrapped around, or removed from, the ITM cylinder surface). Alternatively, an operator may rotate activation screw 30 using an appropriate manual or powered tool.

In accordance with an embodiment of the invention, operations performed for replacing a blanket 25 (e.g. operations represented by blocks of blanket replacement process 100) may be performed by one or more electrically controlled devices, e.g. electric motors or electromagnets. The electrically controlled devices may be controlled by a controller, processor, or similar analog or digital device. For example, a controller or processor may be configured to control the electrically controlled devices in accordance with programmed instructions. The programmed instructions may be stored on a volatile or non-volatile data storage or memory device. The programmed instructions may include instructions to signal an operator, or wait for operator input.

We claim:

1. A blanket tensioning device for an image transfer medium (IT cylinder, the device comprising:
two elongated blanket holders, a long dimension of each blanket holder being substantially parallel to a long dimension of the other, at least a part of at least one of the blanket holders, being moveable toward or away from the other blanket holder;
at least one spring that is longitudinally arranged with respect to the long dimension; and
a transmission for converting a force that is exerted by the spring to a transverse force that is applied to the moveable part, such that when the device is installed on the cylinder with the long dimension being oriented substantially parallel to an axis of the cylinder, and when a blanket is wrapped around the cylinder with each of opposite ends of the blanket being held by each of the blanket holders substantially parallel to the cylinder axis, the applied transverse force tensions the blanket.

2. The device of claim 1, wherein the moveable part comprises a rotatable bar that is rotatable about a rotation axis that is substantially parallel to the long dimension; and wherein the transverse force comprises a torque.

3. The device of claim 1, wherein the spring comprises a compression spring.

4. The device of claim 1, wherein the spring comprises a coil spring or a gas spring.

5. The device of claim 1, wherein the device is installable as a unit in a longitudinal groove in an outer surface of the cylinder.

6. The device of claim 1, wherein one of the blanket holders comprises a static bar.

7. The device of claim 1, wherein the transmission comprises a lever linkage that is rotatable by action of the spring.

8. The device of claim 1, wherein at least one of the blanket holders comprises a clamp.

9. The device of claim 1, comprising an actuation mechanism that may be operated to perform at least one action selected from a list of actions consisting of: apply a counter-torque to the rotatable bar so as to reduce tensioning of the blanket, open a clamp on at least one of the blanket holders, close the clamp, and remove the counter-torque.

10. The device of claim 9, wherein the actuating mechanism comprises a rotatable actuation screw.

11. The device of claim 9, wherein the actuation mechanism comprises a cam.

12. The device of claim 11, wherein the cam is translatable in a direction substantially parallel to the cylinder axis.

13. The device of claim 1, wherein said at least one spring is positioned between the blanket holders.

14. The device of claim 1, comprising a mechanism for applying a counter-torque to the rotatable bar so as to reduce the tensioning of the blanket.

15. A method for tensioning a blanket of an ITM cylinder, the method comprising:
providing a blanket tensioning device that is installed within a longitudinal groove in an outer surface of the cylinder, device comprising:
two elongated blanket holders, a long dimension of each blanket holder being substantially parallel to a long dimension of the other, at least a part of at least one of the blanket holders, being moveable toward or away from the other blanket holder;
at least one spring that is longitudinally arranged with respect to the long dimension; and
a transmission for converting a force that is exerted by the spring to a transverse force that is applied to the moveable part;
wrapping the blanket around the outer surface of the cylinder;
operating each of the blanket holders to hold each of two opposite ends of the blanket substantially parallel to an axis of the cylinder;
operating the device such that the spring exerts a force that is converted by the transmission to a transverse force that is applied to the moveable part so as to tension the blanket.
